(19) United States
(12) Patent Application Publication
(10) Pub. No.: US 2005/0003224 A1
(43) Pub. Date: Jan. 6, 2005

(54) Method of surface modifiacation and coating, and method and apparatus for producing substrate material using the same

(76) Inventor: Shunichi Haruyama, Osaka (JP)

Correspondence Address: DARBY & DARBY P.C., P. O. BOX 5257, NEW YORK, NY, 10150-5257, US

(21) Appl. No.: 10/485,605

(22) PCT Filed: Aug. 1, 2002
(86) PCT No.: PCT/JP02/07878

(30) Foreign Application Priority Data
Aug. 1, 2001 (JP) 2001233750

(51) Int. Cl. B27K 3/02; B32B 18/00; B32B 21/00

(52) U.S. Cl. 428/540; 428/541; 427/430.1; 425/328

(57) ABSTRACT

A method suitable for increasing the hardness, strength, and water resistance of a surface layer such as cedar sheets or cedar plywood is presented. The method does not require a resin component layer such as coating films or resin films provided by the conventional typical coating processes. The method is suitable for modifying surfaces of porous materials such as wooden materials, inorganic materials or ceramic material. Also, the same method can be used for modifying a surface layer portion by impregnating a solution of organic or inorganic matter by using steam and for forming a coating film on the surface.

### FIELD OF THE INVENTION

The present invention relates to a technology which is a modification method suitable for increasing the hardness, strength, and water resistance of a surface layer portion, for example, of cedar sheets or cedar plywood in an easy manner, without providing a resin component layer such as coating films or resin films produced by the conventional typical coating processes, this technology being suitable for conducting surface modification of porous materials such as wooden materials, inorganic materials or ceramic material, and the modification of the surface layer portion from the surface to the prescribed depth by impregnating a solution of organic or inorganic matter by using steam and also for forming a coating film on the surface by the same method.

Furthermore, the present invention also relates to the application of the aforesaid impregnation and coating method to the manufacture of substrate materials suitable for laminates in which a wooden single sheet, veneer, or resin film is laminated with a wooden sheet or inorganic sheet, or for floors, walls, furniture, and the like, that have design decorative materials such as resin films or paper and are provided with a design peak-valley shape such as grooves on the surface thereof, to the substrate materials that can be reliably provided with a design peak-valley shape such as grooves by roll forming or press forming, without rupturing the decorative materials, and in which the design peak-valley shape in the form of grooves and the like is not restored to the original shape due to springback even when the material absorbs moisture or moisture is applied thereto after molding, this substrate material being capable of providing wooden parts with stable plastic deformation which does not change with time after molding, and to the method for the manufacture of such a substrate material.

### BACKGROUND OF THE INVENTION

Wooden materials, in particular coniferous wooden materials such as fir, abies, larch, cedar, cypress, and sawara cypress, are called soft wood because they are soft and lightweight and are widely used as a variety of source materials for construction in the manufacture of core materials with the required cross-sectional shape.

However, the application of sliced single sheets or plywood of soft materials was very limited. Thus, because the sheet surface is soft and can be easily scratched, the soft materials could be used, for example, for construction plywood, whereas their application to flooring or wall materials, which are unavoidably brought into contact, was restricted.

Furthermore, presently the tastes have been shifting from the conventional oak pattern to diffuse-pore patterns such as those of beech, cherry, and maple for floors, walls, and door materials, regardless of whether a solid material or a plywood is used.

Multiple problems of various types that have to be resolved are encountered when a soft wood is used for a surface layer in any usage mode, that is, as a solid material or a plywood of various types. Thus, scratch resistance and indentation resistance are obviously degraded with respect to those of hard materials, and there is the so-called material deviation such that only few materials can meet the floor warming specifications or can be used only under certain conditions and not under others. Moreover, there is a VOC problem associated with adhesives or coating agents used and also a problem of discoloration under the effect of IR radiation such as solar radiation.

In particular, wood materials such as those for floors, walls, and doors are by themselves subjected to machining of grooves or holes, polishing, and press forming to provide them with design features, but measures of various types are necessary to stabilize the moisture content in the wood materials and retain their machinability. Therefore, the wooden materials subjected to machining are also required to have a high surface hardness and water resistance, but optimum aqueous coating materials or aqueous adhesives could not be impregnated into the surface layer of wooden material.

On the other hand, not only various substrates such as plywood of a variety of types, MDF, PB, laminated lumber, and inorganic sheets, but also decorative substrates obtained by pasting a design decorative material such as a resin film, a decorative paper, or a veneer on the aforesaid substrates are well known as the construction material.

Such substrate materials are usually flat and have poor design properties. For this reason, in order to make the flat design to look more three-dimensional, a design surface material is pasted onto a flat sheet and then cutting is conducted with a cutter or groove processing is carried out with a press.

For example, design peak-valleys shapes have been formed by employing a variety of grooving operations, such as forming grooves with V-like cross section by using a flat mold or a roll mold, providing the V-like grooves and then press expanding shoulders, forming U- or V-like grooves with a cutter and then deforming the shoulders thereof into circular arcs, or producing step-like grooves in which the cross-sectional shape of the groove has a step-like form.

The problem associated with groove machining with a cutter is that the design of the groove portion is changed significantly when the material is removed. Furthermore, the problem associated with groove machining with a press is that, the pasted design surface material is ruptured and the zone of plastic deformation created by the press returns to the original state with time.

Plastic deformation provided to wooden material can easily restore to the original state because the fluctuations of input heat and atmosphere humidity easily change the moisture content ratio in the material itself. For example, such a restoration can be caused by moisture absorption by the material itself, and it is well known that restoration to the original state starts immediately if moisture adheres to the machined zone or if heat is additionally applied.

To resolve this problem, permanent strains were provided with a tooling press at a temperature of about 180° C. or higher after molding. However, such a treatment sometimes damaged the design surface material and limited the range of surface decorative materials that could be used. Moreover, it was known that even after such a treatment, if the material was immersed, for example, for 2 min into warm water at a temperature of 70° C., the initial shape was always restored.

### SUMMARY OF THE INVENTION

It is an object of the present invention to provide a method for modifying a surface layer, by which the surface of various materials that could never be coated and impregnated with aqueous coating materials or aqueous adhesives, even essentially porous materials such as wooden materials, inorganic materials, and ceramic materials, is modified by impregnating water-soluble organic or inorganic matter into the surface, an apparatus for the implementation of the method, and a modified product thus obtained.

It is another object of the present invention to resolve the above-described problems inherent to substrate materials having in the surface layer a material that can demonstrate compositional changes, and to provide a substrate material which can be reliably provided with a decorative convex or concave shape such as grooves, without rupturing a decorative material such as paper or a film, in which the decorative convex or concave shape such as grooves is not restored to the original state by the springback even when the material absorbs moisture or moisture is applied thereto after molding, and in which stable plastic deformations that do not change with time after molding can be provided to the wooden portions, and also to a method for the manufacture of such a substrate material, and to a mold for molding.

The inventors have conducted a comprehensive study of the methods for surface modification of soft wood, that can increase hardness, fire resistance, and water resistance of the surface, in particular, without providing a coating of a coating material or the like and without loosing or changing the surface design or beauty of the wooden material itself. First, the attention was focused on the impregnation using a solution of an inorganic substance such as colloidal silica, and methods for impregnating the surface layer of a wooden material, in particular, with silica having moisture removed therefrom were thoroughly studied. The results obtained demonstrated that if colloidal silica is applied to the surface of a wooden material and hot steam is brought into contact with the application surface, while continuously supplying thermal energy so that the steam is not liquefied into droplets, then the colloidal silica applied to the surface of the wooden material is impregnated into the surface layer, while creating bubbles. It was also found that the treatment caused absolutely no changes in the design or state of the surface, such as moistening of the surface after the treatment of formation of the coating film, the entire applied solution could be impregnated, and the presence of the silica in the surface layer portion of the wooden material increased hardness and scratch resistance of this portion.

Further, with respect to the aqueous coating materials or aqueous adhesives that could not be impregnated into wooden materials, the inventors have also found that if, for example, a heating plate maintained at a high temperature is disposed in the vicinity of the application surface and hot steam is brought into contact therewith so that the steam temperature does not drop and the steam is not liquefied into droplets, then the aqueous coating materials are also impregnated, while forming bubbles, the steam exits the wooden material through guide pipes at the thickness end surface thereof, and the components of the applied aqueous coating material are impregnated into the surface layer of the wooden material, without forming a coating film on the surface, and thereby increase the hardness, fire resistance, and water resistance of the surface.

Further, the inventors have also found that in the case of solutions of inorganic or organic matters comprising a mixture of a colloidal silica liquid and a water-soluble coating material or water-soluble adhesive, not only the wooden materials, but also inorganic or ceramic materials that are marketed as various construction materials can be impregnated in the surface layer thereof with the solutions by means of such contact with hot steam It was also found that appropriately selecting a solution of inorganic or organic matters according to the substance which is to be treated makes it possible to provide the surface of wooden materials, inorganic materials, and ceramic materials with properties that were not inherent thereto.

The inventors have also found that providing fine grooves on the surface of the object to be treated such as a wooden material or providing pinholes with an appropriate spacing makes it possible to control appropriately the impregnation rate, efficiency, or depth when the above-described steam impregnation in accordance with the present invention is implemented and also to employ a variety of modification treatments corresponding to the properties of the object to be treated or functions which are wished to be provided with respect to various materials.

Further, the inventors have also studied whether the moisture content of the objects to be treated such as wooden materials change under the effect of steam brought into contact and water present in the solution of organic or inorganic matter in accordance with the present invention. The results obtained demonstrated that the hot steam apparently supplies energy to the coating material components or silica and partially replaces water present in the solution or the material which is to be treated, but it was confirmed that because the operations are conducted so as to replenish the high-temperature energy, for example, by using a heating plate so that the hot steam can demonstrate the energy supplying function, the moisture content somewhat increased in the process of implementing the above-described steam impregnation in accordance with the present invention, but this moisture evaporated naturally after the treatment and the moisture level became the same as before the treatment.

Further, the inventors have also found that the steam impregnation in accordance with the present invention can be similarly employed also when the surface of the material which is to be treated is a veneer pasted, for example, on a laminated material, and a decorative paper or transfer sheet pasted on MDF or the like. The impregnation of the components of the solution of organic or inorganic matter such as water-soluble coating materials can be impregnated not only into the veneer, but also into the surface layer of both the decorative paper or transfer sheet and MDF, and a laminated material having a veneer, decorative paper, or transfer sheet with a high-hardness surface can be manufactured.

Furthermore, the inventors have also established that the steam impregnation in accordance with the present invention can be applied to the case in which a laminated material or a MDF having the aforesaid decorative paper or transfer sheet are subjected to press stamping to provide them with surface design grooves or patterns. In particular, in the prior art, when the moisture content of the material fluctuated after molding by press stamping, the entire material was warped or the grooves and pattern lost their shape due to springback. However, it was found that when the steam impregnation in accordance with the present invention is applied, because decorative paper or transfer sheets are modified by the impregnation with the components of the water-soluble coating material, moisture does not migrate into the plastically deformed surface layer portion from the surface side and from the inside, springback is prevented, the molded shape has a very high stability, and a highly functional construction material with high design ability can be manufactured in an easy manner.

The inventors have also found that the steam impregnation in accordance with the present invention makes it possible to impregnate liquid paraffin as the solution of organic or inorganic matter into the entire wooden material, that is, to impregnate liquid paraffin uniformly in both the thickness direction and the flat surface direction, thereby resolving the problems inherent to the prior art technology, namely, a long time which is required for application and impregnation, application and suction, and pressure permeation in the case of impregnating a very thin surface layer, and also non-uniformity of the coating and impossibility to impregnate liquid paraffin in the zones at a large depth from the surface.

Moreover, the inventors have found that the steam impregnation in accordance with the present invention makes it possible to use water-soluble coating materials or water-soluble adhesives that are polymerizable with UV radiation or electron beam as the solution of organic or inorganic matter and to impregnate them into any material selected from wooden materials, inorganic materials and ceramic materials, and that because the resin components are completely polymerized by irradiation with UV radiation or electron beam after the impregnation, the treated surface layer can be provided with excellent functions such as a high hardness and high corrosion resistance.

The above-described information obtained by the inventors demonstrated that with the steam impregnation method employing hot steam and the heating plate, it is possible to control the degree to which the components of solutions of organic or inorganic matter, such as water-soluble coating material, are impregnated into the surface layer. Therefore, a coating film can be formed on the surface by appropriately controlling the temperature of the hot steam and heating plate. Moreover, coating films of water-soluble coating material that have been conventionally considered to have insufficient adhesive properties can be integrated with the same coating material that was previously impregnated and solidified and a water-soluble coating material film with excellent adhesive properties can be formed.

The inventors who had developed the above-described steam impregnation method and coating method have also conducted a comprehensive study of roll or press molded shapes such that cause no rupture of the surface layer of the substrate materials themselves or design surface materials provided on the surface thereof and that also produce the molded convex or concave shape such as grooves in which no springback occurs. The results of this study demonstrated that the longitudinal cross-sectional shape of the mold protrusion for forming the groove shape has to be formed entirely, including the tip end of the mold, from circular arc surfaces of appropriate radii, rather than to be a shape composed of straight line sections as the conventional so-called V-like shape or almost V-like shape.

Furthermore, the inventors have further studied the longitudinal cross-sectional shape of the mold protrusion. The results obtained demonstrated that the shape is required which is formed entirely, including the tip end of the mold, from circular arc surfaces of appropriate radii, or in which, as in the U-like shape, the length of the portions almost-parallel to the sheet material in the groove width direction is maximum about 1 mm (only in the distal end portion), the almost flat portion of the distal end of the mold is 0.3 to 1 mm, and all other sections are formed by circular arcs of appropriate radii, or in which the straight linear sections are present in the distal end portion and all other sections are formed by circular arcs of appropriate radii, the latter shape being used when the height of the protrusion for forming the groove is above 2 to 2.5 mm.

Further, the inventors have also focused their attention on conducting the modification treatment of the surface layer portions so that plastic deformation after the press molding of the groove shape is not restored to the original state under the effect of moisture associated with the springback of plastically deformed portions when the aforesaid mold is used, and have conducted a comprehensive study of such a treatment. The results obtained demonstrated that this object can be attained by impregnating the substrate surface layer with a solution of organic or inorganic matter, for example, components of water-soluble coating material, comprising colloidal silica or SiO₂ fine particles by the previously discovered steam impregnation method.

Thus, the inventors have found that in the case of a configuration in which design grooves or patterns are press stamped on the surface as in the laminated materials and MDF materials having the aforesaid decorative paper or printed sheet, in particular, when the moisture content in the material fluctuates after the press stamp molding, the entire material is warped or the grooves and patterns lose their shape due to springback. However, if the steam impregnation method in accordance with the present invention is applied, the decorative paper and resin sheets are modified by impregnation with the components of water-soluble coating materials. Therefore, moisture does not migrate into the plastically deformed surface layer from the surface side and inner side, the springback is prevented, the molded shape is very stable, and a highly functional construction material with high design ability can be manufactured in an easy manner.

### BRIEF DESCRIPTION OF THE DRAWINGS

FIG. 1 is a longitudinal sectional view illustrating the cross-sectional shape of the protrusion of the mold in accordance with the present invention;

FIG. 2 is an explanatory drawing illustrating the shape of the groove provided on the surface of the MDF sheet material;

FIG. 3 is a top view illustrating the arrangement configuration of the impregnation-coating apparatus in accordance with the present invention;

FIG. 4 is an explanatory drawing of the impregnation and coating apparatus in accordance with the present invention; and

FIG. 5A is a partial side view of the heating plate used in the impregnation and coating apparatus in accordance with the present invention, and FIG. 5B is an explanatory drawing of the steam nozzle portion.

### DETAILED DESCRIPTION OF THE INVENTION

Method for Surface Layer Modification and Impregnation

Experiments that led to the conception and creation of the present invention and the working examples thereof will be described hereinbelow in greater detail. The inventors have earlier discovered that if an organic or inorganic coating material is prepared by uniformly dispersing silica with a particle size of a nanometer class, without cohesion, in a certain organic solvent and this coating material is applied to a thin cedar sheet, then this coating material unexpectedly becomes impregnated in the surface layer of the material.

The organic solvent that can uniformly disperse silica of a nanometer class is required to satisfy specific conditions and has to have a prescribed molecular weight correspondingly to the size of silica, and those conditions lie in a very narrow range. Furthermore, the organic or inorganic coating material having silica of a nanometer class uniformly dispersed therein seemed to be activated to provide it with a capacity to permeate into the other material after the application. Moreover, in some cases, this coating material lost its energy after a fixed interval, secondary cohesion of silica was initiated, and the initial permeation capacity was decreased.

On the other hand, taking into account the environmental problems, it is preferred that aqueous coating material be used for surface treatment of wooden materials and the like, and aqueous coating materials of a variety of types have been disclosed. However, for those skilled in the art of coating materials and timber industry it was a common knowledge that the aqueous coating materials demonstrate a comparatively weak adhesion even to materials with a low content of fats, the coated films of aqueous coating materials easily peel off from the materials with a high content of fats, and even if the aqueous coating material is applied, it cannot be impregnated.

The inventors have studied environmental pollution and solubility in water of the conventional organic or inorganic coating materials that can cause silica to demonstrate a permeation capacity, focused their attention on the possibility of impregnating a thin sheet of cedar with colloidal silica and investigated this possibility. The results obtained suggested that in the conventional organic or inorganic coating materials, silica in the form of ultrafine particles was uniformly dispersed in a resin with a specific molecular weight allowing the energy inherent to the silica to be used effectively, but with colloidal silica, typically a state was obtained in which silica designed for secondary cohesion was dispersed with difficulty by pH adjustment or by using a solution with specific ions introduced therein, the conditions allowing the energy inherent to the silica to be used effectively were not realized, and the colloidal silica applied to a thin sheet of cedar absolutely could not be impregnated therein.

Accordingly, the inventors have conducted a comprehensive study of methods for activating silica that was barely dispersed in a colloidal state and have discovered that silica can be activated and impregnated into the surface of a wooden material if energy is provided thereto by using steam, that is, if hot steam is brought into contact after colloidal silica has been applied to the wooden material surface.

An experiment that led to this discovery will be described below. First, the weight (130 g per 1 m²) of a wooden material to be treated (cedar sheet) and colloidal silica (content of solids 30%, silica particle size 10 nm) which is to be applied was measured and the colloidal silica was applied to the wooden material surface. Then, hot steam (145° C., commercial industrial steam generator) was brought into contact till moisture present on the coated surface has disappeared, and the weight of the wooden material to be treated was measured again. Further, hot steam was also brought into contact with a wooden material identical to the aforesaid wooden material for a treatment time that was required for the aforesaid treatment and the increase in moisture content caused by such a contact was measured. As a result, an increase of about 2% was confirmed, but when the wooden material was thereafter allowed to stay and the weight thereof was measured again, the respective decrease in weight by 2% was configured.

After colloidal silica has been applied, steam was brought into contact till the surface was dried, and the weight of the wooden material was measured. As a result, the increase in weight was confirmed to be equal to that of the colloidal silica solids and 2% of the own weight of the wooden material. Weight measurements conducted after the wooden material was allowed to stay confirmed the increase in weight corresponding to the weight of solids (about 40 g per 1 m²).

The wooden material (cedar sheet) prior to the treatment could be scratched with a nail, whereas the wooden material after steam impregnation could not be easily scratched and practically no scratches were formed even when the force that damaged the tip of the nail was applied. Those results confirmed that silica impregnation was carried out in the aforesaid steam impregnation and that the surface layer of the cedar material was modified.

Then, in place of cedar sheet, when commercial soft materials of various types such as larch, cedar, and cypress, single sheets of hard materials such as Japanese cypress, or plywood obtained by bonding such materials on the surface were applied and impregnated with colloidal silica by conducting steam impregnation under the same conditions as described above, in all the cases the improvement effect resulting in hardness improvement of wooden material surface was obtained as described above.

It was found that in all the wooden materials, application of colloidal silica to the wooden material surface and impregnation by the above-described hot steam required a rather long time or a large amount of steam was required to dry the surface of the sheets.

Accordingly, the implementation methods designed to conduct the impregnation efficiently were studied, the attention was focused on the moisture content of colloidal silica and continuous supply of a large quantity of energy to the silica, and those issues were comprehensively studied. If hot steam is used together with a heating plate as in the commercial steam irons, and heat convection of the steam acting upon the application surface of colloidal silica is induced between the surface and the heating plate, then energy is supplied so that steam that looses energy and forms water droplets is eliminated. As a result, when the applied quantity were identical to that of the prior experiment, colloidal silica was impregnated while foam was being formed, the impregnation capacity was increased to the degree confirmed by immediate exit of steam from the end surfaces of a single sheet, and the weight measurements carried out in the above-described manner confirmed that the entire silica was impregnated.

Furthermore, a large number of combinations of devices and conditions were tested so as to obtain various quantities of steam supplied to the treatment surface and heat supplied from the heat source, for example, by using only the ejection of industrial steam and the combinations of the industrial steam injection with commercial hot steam irons and heating plates in which an electric heater was provided in an iron plate with a thickness of 5 to 10 mm, or by varying the distance between the iron or heating plate and the treatment surface (3 to 20 cm). The results obtained demonstrated that the impregnation rate increased regardless of the difference between the conditions relating to the treatment surface state, and that impregnation and drying proceeded rapidly within several seconds and several minutes when the steam temperature was high and the quantity of heat received from the heating source was large, that is, when the total quantity of energy obtained from steam and heating plate within a unit time was large, and when the conditions were optimized so that the convection between the surface and the heating plate (about 200° C.) was repeated without causing the steam which was brought into contact with colloidal silica to form the droplets of water.

Further, steam impregnation of colloidal silica was also conducted under the above-described conditions with respect to objects to be treated other than the above-described wooden material, for example, with respect to a variety of commercial sintered sheets manufactured from volcanic ash, ceramic plates, fired ceramic sheets that were not subjected to surface treatment, and also resin sheets and degraded gel coating films that were coated on ships. The impregnation process and operation obtained were identical to those obtained in the case of wooden materials and the increased surface hardness was confirmed.

Further, solutions of organic or inorganic matter were prepared by varying the particle size of the colloidal silica within a range of from 7 nm to 50 nm, using only a commercial water-soluble acrylic coating material (acryl-urethane resin content 50%), and preparing mixed solutions of the water-soluble acrylic coating material and colloidal silica, the solutions were applied under the conditions identical to the above-described conditions to a variety of usual plywood and construction plywood that are available as the so-called do-it-yourself (DIY) products, that is, broad-leaved tree plywood (Japanese linden, birch, castor aralia, beech, oak, meranti, apitong, kapur), coniferous tree plywood (larch, Yezo spruce, cedar, Japanese red pine, larch, Douglas fir, western hemlock, spruce, radiate pine), cedar veneer, cedar planks, cedar plywood, pine veneer, pine sheets, and also copy paper, Japanese paper, sintered sheets made from volcanic ash, ceramic sheets, fired ceramic sheets, resin sheets, resin films, available for DIY, and gel coat films, and the applied solutions were steam impregnated.

A brush application method, a spray application method, and a roll application method were appropriately selected according to the combination of the solution and the object to be treated as the method for applying various solutions organic or inorganic matter. The applied amount varied accordingly.

Steam impregnation was implemented by the following five methods.

(1) Steam generator (100° C.+α)

(2) Industrial steam generator (145° C.)

(3) Industrial steam iron was used (iron temperature 130° C., distance 5 cm, steam temperature 100° C.+α).

(4) Heating plate and steam generator (heating plate temperature 150° C., distance 5 cm, steam temperature 100° C.+α)

(5) Heating plate and industrial steam generator (heating plate temperature 200° C., distance 5 cm, steam temperature 145° C.).

(6) Heating plate and industrial steam generator (heating plate temperature 230° C., distance 5 cm, steam temperature 200° C.)

With the steam impregnation in accordance with the present invention, good impregnation was confirmed for all the combinations of the above-described solutions and objects to be treated. However, the operation effect differed depending on the steam impregnation method and the impregnation effect increased in the order of the aforesaid means (1) to (6) for all the objects to be treated. The increase was especially significant in the order of means (4) to (6).

For example, it was a matter of common knowledge for those skilled in the art that though aqueous acrylic coating materials could be applied to the surface of, e.g., cedar and pine sheets, they could not be impregnated into the surface layer and that they could not be impregnated into inorganic material and porous materials such as ceramic sheets. However, with the invention method, they could be impregnated.

The above-described means (1) and (2) were found to be effective for impregnating water-soluble acrylic coating materials, but could hardly induce the impregnation of water-soluble acrylic compositions containing silica and required an iron or a heating plate as a heating source. Thus, in order to modify physical properties in the surface layer by impregnating silica, it is necessary to raise the temperature to a certain level and the so-called hot dry steam with a temperature of about 200° C. may be used.

In accordance with the present invention, after the steam has applied energy to the organic or inorganic matter present in the treatment solution, it has to be immediately scattered from the surface or from the inside of the surface layer. Thus, for example, a heating plate may be arranged opposite the application surface and an atmosphere where heat convection can proceed may be created between the heating plate and the treatment surface by continuously or intermittently introducing steam into the gap between the opposing surfaces, while conducting heating of the application surface, so that the steam has the energy allowing for evaporation and dissipation from the surface or the inside of the surface layer after the energy has been applied to organic or inorganic matter or that such energy can be immediately supplied to the steam.

Therefore, when the application surface which is to be treated is wide, a heating plate may be arranged opposite the application surface and heating and convection of steam may be conducted by continuously or intermittently introducing steam from the heating plate itself or from the clearance between a plurality of arranged heating plates into the gap between the application surface and opposing surface, while heating the application surface.

Furthermore, the impregnation can be carried out more efficiently by activating the steam and organic or inorganic matter by using ultrasound vibration means in the impregnation process or heating process implemented for drying, solidification, and stabilization, and heating the object to be treated before, after or during the application.

In accordance with the present invention, besides the method using contact with hot steam, other methods such as using the aforesaid heating plate, simultaneously conducting heating and pressing with a well-known hot press machine for timber industry, or conducting induction heating can be used for heating conducted for drying, solidification, and stabilization after the impregnation.

In accordance with the present invention, any well-known solutions containing colloidal silica, water-soluble coating materials, water-soluble adhesives, and the like can be employed as the solution of organic or inorganic matter. Further, water-soluble coating materials and water-soluble adhesives comprising inorganic fine particles with a size of from several nanometers to several micrometers, for example, ceramics such as silica, alumina, and magnesia and various pigments used in coating materials, and water-soluble adhesives, and also water-soluble coating materials and water-soluble adhesives having colloidal silica mixed therewith can be employed as the solutions of organic or inorganic matter. If the particle size of the pigment is too large, it will not be impregnated, and a nanometer class of pigments with a particle size of 1 micron or less is preferred. Further, the same operation effect in steam impregnation is obtained even with the coating materials using organic solvents and coating materials using organic solvent comprising ceramics, pigments, and the like, but from the standpoint of environment, water-soluble systems with small evaporation are preferred.

Any colloidal silica, from typical alkaline to neutral, with a silica particle size of from several nanometers to several tens of micrometers can be employed, but from the standpoint of impregnation into wooden materials, neutral colloidal silica with a particle size which is not too small is preferred. A method can be also employed in which the particles are initially comparatively large and then gradually decrease in size.

Further, in accordance with the present invention, liquid paraffin can be employed as the solution of organic or inorganic matter in accordance with the present invention because in liquid paraffin, resin particles of a nanometer class have flowability similarly to colloidal silica and behave as a liquid. Further, it is possible to obtain an operation effect of increasing the hardness of the material similarly to nanometer class silica after impregnation into wooden materials or inorganic materials and the aforesaid effect is not lost because liquid paraffin is not evaporated within the temperature range in which wooden materials are used.

Liquid paraffin typically represents a composition in which no wax components are contained in the paraffin. In order to conduct steam impregnation, a liquid paraffin has to be used in a form in which the boiling point thereof is as higher than the steam temperature as possible.

In particular, the modification method in accordance with the present invention comprises a step of bringing steam into contact with the application surface of a solution of an organic or inorganic matter and impregnating the solution of the organic or inorganic matter at least into the surface layer of the object to be treated, and a step of further heating the treatment surface or the entire object to be treated. However, as shown in the working examples, if hot pressing is conducted after steam impregnation of liquid paraffin into paper or a paper-like thin-sheet material, the paper is entirely resinified and the thin-sheet material is also almost resinified.

Furthermore, in accordance with the present invention, a water-soluble coating material of oligomers and monomers that can be radical polymerized, cured, and solidified by electron beams can be used as the solution of organic or inorganic matter. Conducting electron beam irradiation after such water-soluble coating materials have been impregnated into wooden materials, inorganic materials, ceramics, and like, makes it possible to completely solidify the resin component in the material and integrate it with the material. As a result, a very strong material can be produced from the soft material. Such a process can be conducted together with the below-described coating process.

Coating and Application Method

In accordance with the present invention, it was clarified that impregnation can be carried out by maintaining the temperature of the object to be treated at a certain high temperature. Conversely, conducting appropriate cooling such that the temperature of the object to be treated is not raised to above the necessary level by the heating plate makes it possible to conduct coating of the water-soluble coating material in the above-described impregnation process and similar processes. The advantage of such a procedure is that the film obtained is dense and has a uniform thickness.

Thus, a coating material is impregnated into the surface layer of the coating object by forming a steam atmosphere between the coating object that has a water-soluble coating material applied thereto and the heating plate which was arranged close to the surface that was planned to be coated and raising the steam temperature or raising the temperature of the object to be treated. The amount of the water-soluble coating material that is impregnated into the surface layer of the application surface can be controlled by controlling at least one temperature selected from the coating object temperature, coating material temperature, and steam temperature. In particular, the water-soluble coating material can be solidified on the surface as a coated film by controlling the temperature of the coating object to the prescribed level.

Here, if a steam atmosphere is formed between the heating plate arranged close to the surface that is planned to be coated and the surface, then the moisture present in the applied water-soluble coating material can be gasified and removed with the steam. Typically, water-soluble coating materials are composed so as to solidify immediately and form a film once the moisture present therein is removed. However, it is well known that moisture cannot be easily removed even by hot-air drying, let alone the normal-temperature drying, and that uniform moisture removal is impossible. In accordance with the present invention, the hot steam atmosphere present between the heating plate and the surface to be coated can remove the moisture present in the water-soluble coating material with good efficiency and the moisture can be removed within a short time and with good uniformity. As a result, a film with excellent properties can be obtained.

Further, in accordance with the present invention, the impregnation using steam and the coating process obviously can be conducted separately, a coating process can be implemented after the impregnation process and once the object to be treated has been temporarily cooled, by using a heating plate and steam generator identical to those used in the impregnation process. Moreover, the coating process can be also continuously carried out after the impregnation process by using means for cooling the object to be treated. In this case, a homogeneous coated film can be formed not only when the water-soluble coating material which is to be solidified has been newly applied, but also when the water-soluble coating material remained on the surface of the object to be treated in the preceding impregnation process.

The aforesaid cooling means can be easily applied by any well-known processing and manufacturing apparatuses, for example, by installing a water cooling apparatus on a bed carrying a panel for timber industry.

In the coating process, the temperature control of the coating object is preferably conducted so that the heating temperature of the coating object at least during the impregnation is 45° C. or higher and the temperature of the coating object during solidification of the coating material is 40° C. or lower. Furthermore, it is even more desired that the heating temperature be 50° C. or higher and that the temperature of the coating object during solidification of the coating material be 30° C. or lower.

In accordance with the present invention, a similarly high steam temperature is preferred in both the impregnation method and the coating method, and the preferred temperature is 120° C. or higher, even more preferably 140° C. or higher. As for the steam pressure, it is not necessary that steam be ejected under a high pressure onto the treatment surface or into the atmosphere between the treatment surface and the heating plate. However, it is preferred that the steam pressure just before releasing between the heating plate and the surface to be coated be high. Thus, the pressure is preferably 2 MPa or higher, even more preferably 4 MPa or higher.

In accordance with the present invention, a similarly high heating temperature is preferred in both the impregnation method and the coating method. Thus, the temperature is preferably 200° C. or higher, even more preferably 300° C. or higher. Furthermore, the distance between the heating plate and the surface which is planned to be impregnated or coated is preferably maintained at about 5 to 20 mm.

In accordance with the present invention, the water-soluble coating material used in the impregnation method or coating method is preferably a water-soluble coating material or water-dispersible coating material containing as the main component any of alkyd resins, melamine resins, urea resins, phenolic resins, acrylic resins, and epoxy resins. In particular, water-soluble coating materials are preferred in which a resin component and fine inorganic particles are dispersed in an aqueous solvent. Furthermore, it is also preferred that the amount of solid components be as low as possible. Thus, it is preferred that the content ratio of the resin component be 20 wt. % or less and the content ratio of the fine inorganic particles be 5% or less. It is more preferred that the content ratio of the resin component be 15 to 18% and the content ratio of the fine inorganic particles be 2 to 5%, and it is even more preferred that the content ratio of the resin component be 10% or less and the content of the fine inorganic particles be 3% or less. Further, some of the above-described water-soluble coating material components are directly used as adhesives, and it goes without saying that such an adhesive can be applied by the coating method in accordance with the present invention and that other material can then be pasted or the so-called transfer can be conducted.

Furthermore, a variety of the above-described ceramic particles can be used as the aforesaid fine inorganic particles. SiO₂ with a mean particle size of 50 nm or less is preferred. When impregnation and coating are conducted, the fine inorganic particles of the water-soluble coating material during the impregnation process preferably have a mean particle size of 20 nm or less, and the fine inorganic particles of the water-soluble coating material during the coating process preferably have a mean particle size of more than 20 nm and not more than 50 nm.

The impregnation or coating apparatus for the implementation of the method for the modification (impregnation method) of the surface layer or coating method in accordance with the present invention preferably has the following configuration.

(1) An apparatus for carrying or supporting a coating object, which is equipped with heating or cooling means for obtaining the prescribed temperature of the object to be treated.

(2) An application apparatus for applying a water-soluble coating material (solution of inorganic or organic matters) to the prescribed surface of the object to be treated.

(3) A heating plate apparatus in which the heating plate is disposed in the vicinity of the surface which is planned to be impregnated or coated and this heating plate is maintained at the prescribed temperature.

(4) A steam generation apparatus in which steam maintained at a high temperature and under a high pressure is released into a gap between the surface which is planned to be impregnated or coated and the heating plate and a steam atmosphere is formed in the gap. Those apparatuses shall provide for conditions preferred for each process which is clarified in the below-described method for the manufacture of a substrate material

Substrate Material and Method for Manufacture Thereof

A method for industrial application of the modification method employing the above-described steam impregnation will be descried below.

In accordance with the present invention, no specific limitation is placed on the substrate material which is the object to be treated for the above-described steam impregnation or coating. In the explanation below, there will be considered single sheets of wooden materials or inorganic material, laminates comprising wooden materials or inorganic materials, or the single sheets or laminates having a decorative material on the surface thereof that make it possible to obtain a significant effect of the above-described invention. Thus, any conventional substrates can be employed, those substrates including single sheets of wooden materials of coniferous or broad-leaved trees that can be called soft materials or hard materials, plywood thereof, glued laminated wood, MDF obtained by fixing wood chips or wood dust with a resin, PB, inorganic sheets such as calcium carbonate sheets, laminates thereof, laminates thereof with metals, and also single sheets, or laminated sheets that have on the surface thereof a decorative material such as veneer, paper, or resin film.

The impregnation process in which the surface layer of the substrate material is impregnated with a solution of organic or inorganic matter comprises a step of applying the solution of organic or inorganic matter to the surface of the object to be treated, a step of bringing steam into contact with the application surface and impregnating at least organic or inorganic matter present in the solution at least into the surface layer of the object to be treated, and optionally further a step of heating the treatment surface or the entire object to be treated.

In short, with such a steam impregnation process, when the temperature of the steam applied to the substrate material is high, when quantity of heat received from the heat source is large, that is, when the total energy of the heat and from the heating plate that is received within a unit time is large, and when the conditions of repeating heat convection between the treatment surface and the heating plate (about 200° C.) are optimized, without causing the steam which is in contact with colloidal silica to liquefy into droplets, the impregnation rate is increased regardless of the difference in conditions relating to the treatment surface state, and the impregnation and drying are conducted rapidly within several seconds or several minutes.

After the steam has applied energy to the organic and inorganic substances present in the treatment solution, it has to be immediately scattered from the surface or from the inside of the surface layer. Thus, for example, a heating plate may be arranged opposite the application surface and an atmosphere where heat convection can proceed may be created between the heating plate and the treatment surface by continuously or intermittently introducing steam into the gap between the opposing surfaces, while conducting heating of the application surface, so that the steam has the energy allowing for evaporation and dissipation from the surface or the inside of the surface layer after the energy has been applied to organic and inorganic substances or that such energy can be immediately supplied thereto.

Therefore, when the application surface which is to be treated is wide, a heating plate may be arranged opposite the application surface and heating and convection of steam may be conducted by continuously or intermittently introducing steam from the heating plate itself or from the clearance between a plurality of arranged heating plates into the gap between the application surface and opposing surface, while heating the application surface.

Furthermore, the impregnation can be carried out more efficiently by activating the steam and organic or inorganic matter by using ultrasound vibration means in the impregnation process or heating process implemented for drying, solidification, and stabilization, and heating the object to be treated before, after or during the application.

Besides the method using contact with hot steam, other methods such as using the aforesaid heating plate, simultaneously conducting heating and pressing with a well-known hot press machines for timber industry, or conducting induction heating can be used for heating which is conducted for drying, solidification, and stabilization after the impregnation.

In accordance with the present invention, the aforesaid steam impregnation method is implemented as a pre-processing or after-processing in the manufacture of substrate materials, in particular, for a molding process in which roll forming or press forming is conducted to form peaks and valleys on the surface layer of the substrate material, thereby modifying the material surface where such forming is to be conducted or modifying the material surface that has been subjected to forming. As a result, various peak-valley shapes such as grooves or patterns that were formed by plastic deformation under applied pressure do not return to the original shape due to the so-called springback even when the material itself is moistened or brought into contact with moisture or heat.

In accordance with the present invention, any well-known solutions containing colloidal silica, water-soluble coating materials, water-soluble adhesives, and the like can be employed as the solution of organic or inorganic matter. Further, water-soluble coating materials and water-soluble adhesives comprising inorganic fine particles with a size of from several nanometers to several micrometers, for example, ceramics such as silica, alumina, and magnesia and various pigments used in coating materials, and water-soluble adhesives, and also water-soluble coating materials and water-soluble adhesives having colloidal silica mixed therewith can be employed as the solutions of organic or inorganic matter. If the particle size of the pigment is too large, it will not be impregnated, and a nanometer class of pigments with a particle size of 1 μm or less is preferred. Further, the same operation effect in steam impregnation is obtained even with the coating materials using organic solvents and coating materials using organic solvents comprising ceramics, pigments, and the like, but from the standpoint of environment, water-soluble systems with small evaporation are preferred.

Modifying the surface of the substrate material which is to be subjected to molding or the surface thereof that has already been molded with the steam impregnation method, that is, causing the impregnation of colloidal silica or water-soluble coating material thereto increases hardness and strength of the material in the impregnated surface layer and also prevents the migration of moisture, thereby preventing the occurrence of springback.

With this steam impregnation method, absolutely no solution or coating material components remain on the surface regardless of whether the solution which is employed for impregnation comprises colloidal silica or a water-soluble coating material. Therefore, when a coating is required on the substrate material, the above-described coating method employing steam or a well-known coating process is implemented appropriately and timely according to the subsequent processing after the aforesaid impregnation process.

In accordance with the present invention, all the well-known roll molding methods or press molding methods for timber industry can be employed for the molding process and metal molds for molding used for forming peaks and valleys in the surface layer of the substrate material, and the appropriate method is selected according to the shape of the concave or convex which is to be molded.

In particular, when grooves are formed or in the case of a substrate material having a thin decorative material pasted thereon, a metal mold having a novel protrusion shape in accordance with the present invention may be used. Thus, the metal mold for the roll molding method and press molding method in accordance with the present invention comprises an R-like protrusion of a circular arc form and has no straight lines, wherein the cross-sectional shape thereof in the vertical plane going directly along the longitudinal direction of the protrusion is composed of a plurality of circular arcs.

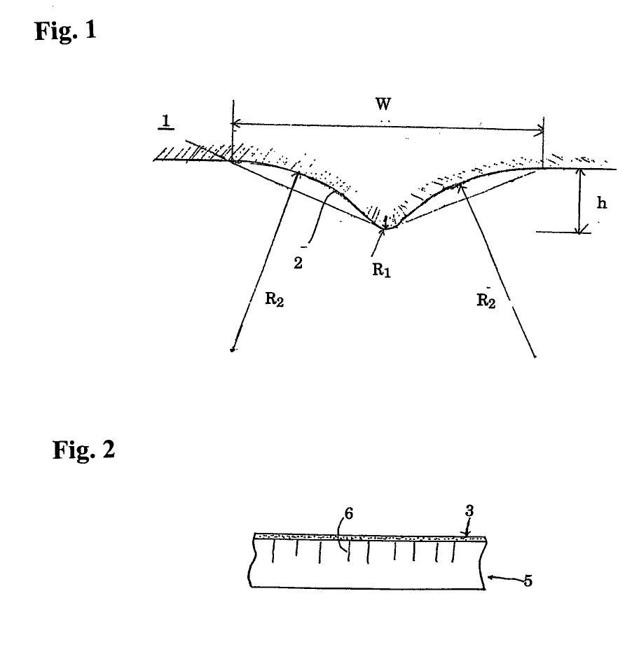

A roll metal mold 1 for molding grooves by a roll molding method will be described hereinbelow in greater detail. The cross section in the vertical plane going directly along the longitudinal direction (tangential direction of rolls) of the protrusion 2, as shown in FIG. 1A, has a symmetrical shape with the tip of the protrusion 2 as a center of symmetry, and the tip of the protrusion 2 is formed by a circular arc with a radius R1 and circular arcs with respective radii R2 on both sides thereof. The protrusion can have the following dimensions (not shown in the figure). For example, when the protrusion height is 1.7 mm, an R protrusion is composed which has a total protrusion width W of 8 mm, a radius R2 of 5 mm, a radius R1 of 0.3 mm, the so-called protrusion opening angle of about 1300, and a cross sectional shape containing no straight lines.

If molding is conducted by using the roll metal mold having the R protrusion containing no straight lines in the cross section thereof, R (rounded) grooves of the prescribed depth can be molded in the substrate material having a thin decorative paper pasted thereof, without rupturing the thin low-strength decorative paper. Furthermore, with the grooves formed with V-like protrusions with a cross section composed of straight segments, as with the conventional so-called V-like mold or almost V-like mold, springback easily occurs under the effect of moisture or heat. By contrast in the case of R (rounded) protrusions, springback occurrence is effectively prevented. Therefore, in molding with the R protrusion springback can be prevented by a combined effect of the protrusion with the modification effect of the above-described steam impregnation.

The protrusion of the moll used for producing grooves with a comparatively large depth, for example, with a protrusion height of more than 2 mm, as shown in FIG. 1B, has U-like almost straight portions only in the tip portion of the protrusion having the aforesaid radius R1. As for other shapes, from the standpoint of preventing the rupture of the decorative material and springback it is preferred that the R protrusion have a shape consisting of one or a plurality of circular arcs. Further, from the standpoint of demonstrating a higher operation effect, it is preferred that the molding method using the metal mold in accordance with the present invention be conducted at a mold pressure higher than that employed in the conventional methods.

Further, the aforesaid springback prevention effect can be further stabilized by implementing the molding process after the impregnation process or by employing a heating and drying method such that comprises disposing the heating plate in the vicinity of the surface of the substrate material that passed the impregnation process and heating the material after the molding process, or simultaneously conducting heating and pressing in the well-known hot press apparatus such as used in the timber industry, or conducting high-frequency heating.

Furthermore, in accordance with the present invention, a process can be employed in which a water-soluble coating material or adhesive polymerizable by UV radiation or electron beam is used in the solution of organic or inorganic matter, a molding process is implemented by roll molding or press molding before or after the impregnation process in which the aforesaid solution is impregnated, then coating is carried out, and finally the treated surface is irradiated with UV radiation or electron beam to polymerize and solidify the surface layer and the impregnated organic or inorganic matter. The modification effect of the material surface layer accompanying the impregnation is further increased and the stabilization of the modification effect obtained is further improved by the aforesaid series of processes.

### WORKING EXAMPLES

### Working Example 1

A wooden floor material was fabricated which had a novel configuration in which a hardwood, a usual lauan, a hardwood, Japanese paper, and a cherry veneer with a thickness of 0.2 mm were laminated in the order of description from the base material side. An inexpensive hardwood-pasted lauan plywood with a size of 3×6 feet that was obtained by laminating a hardwood, a usual lauan, and a hardwood in the order of description was used for the base material.

The production process comprises the steps of:
adjusting the thickness of the lauan plywood by top-surface polishing (tolerance not more than ±0.2 mm);
applying a glue with a glue spreader (urea resin+vinyl acetate);
setting the Japanese paper;
applying a glue with a glue spreader (urea resin+vinyl acetate);
setting the cherry veneer;
steam impregnating A; and
hot pressing the veneer (for 1 min at 110° C.).

The steam impregnation A was conducted by the method comprising the steps of applying colloidal silica (contents of solids 30%, silica particle size 30 nm) with a roll coated to the surface of the cherry veneer at a ratio of 130 g/m², then arranging a heating plate (180° C.) which is to be used in the hot pressing process in position at a distance of 50 mm from the application surface, and injecting hot steam (145° C.) into the gap thus formed.

In the wooden floor material of the above-described configuration, a very thin cherry veneer (thickness 0.2 mm) is lined with Japanese paper and the veneer is impregnated with silica of a nanometer side class. As a result, damage of the veneer caused by heat or scratching is prevented and the migration of moisture from the base material side is reduced.

Furthermore, when the amount of applied colloidal silica was increased and the heating plate temperature was raised to 220° C., silica reached the Japanese paper and the migration of moisture from the base material side into the veneer was further reduced.

In other words, in wooden floor materials, the requests to shift from the oak patterns to diffuse-pore wood patterns such as beech, cherry, and maple, resulted in a variety of problems associated with the veneers made from those diffuse-pore materials, those problems including degraded resistance to scratches and indentations, vibrations of the materials occurring when the floor warming specifications are met, discoloration caused by sunlight, and VOC. However, the steam impregnation in accordance with the present invention was implemented in the cherry veneer of the coating material and optionally additionally in the Japanese paper, whereby all the above-described problems were resolved.

In the steam impregnation process A, a water-soluble acrylic coating material, trade name KD-20, content of solids 30%, manufactured by NSC Co.) was used instead of colloidal silica, applied with a roll coater on the cherry veneer surface at a ratio of 100 g/m², and then steam impregnated under the same conditions as described hereinabove. In this case absolutely no resin layer was observed on the surface and the weight measurements configured that the entire amount was impregnated.

Furthermore, while the water-soluble acrylic coating material is typically considered to be almost impossible or very difficult to apply and impregnated, the average molecular weight of the resins was rather uniformly low and pigments of a nanometer class were used, thereby providing for tight adhesion to the surface layer of the plywood could be obtained. However, even in those cases, when the coating material was applied at a ratio of 50 g/m² and dried to solidify, and then a coated film was peeled off as thoroughly as possible and the weight of the peeled film was measured, the results was at least 45 to 48 g. Therefore, it is clear that the water-soluble acrylic coating material is very difficult to apply and impregnate.

### Working Example 2

A wooden floor material of the same configuration as in the Working Example 1 was fabricated by the process identical to that of the Working Example 1, except that the steam impregnation process was implemented after the Japanese paper setting process. The strength of the entire plywood was increased and the migration of moisture from the base material side to the plywood was almost entirely prevented.

Furthermore, a separate steam impregnation process B and Japanese paper hot pressing process (for 1 min at 110° C.) were carried out after the Japanese paper setting process. Thus, a method was used by which liquid paraffin (boiling point 230° C.) was applied instead of colloidal silica of the steam impregnation process A, a heating plate (180° C.) which is to be used in the hot pressing process was arranged in position at a distance of 50 mm from the application surface, and hot steam (145° C.) was injected into the gap thus formed, followed by hot pressing (for 1 min at 110° C.). As a result, the Japanese paper was converted into a resin sheet. Obviously the adhesion with the cherry veneer showed absolutely no changes with respect to that of Working Example 1.

### Working Example 3

A wooden floor material of the same configuration as in Working Example 1 was fabricated by the process comprising the steps of:
adjusting the thickness of the lauan plywood by top-surface polishing (tolerance not more than ±0.2 mm);
applying a water-soluble acrylic coating material with a roll coater;
setting the Japanese paper;
steam impregnating C;
hot pressing the Japanese paper (for 1 min at 110° C.);
applying a glue with a glue spreader (urea resin+vinyl acetate);
setting the cherry veneer;
steam impregnating A; and
hot pressing the cherry veneer (for 1 min at 110° C.).

The steam impregnation C was conducted by the method comprising the steps of using instead of colloidal silica of the steam impregnation process A a mixed solution prepared by mixing colloidal silica with the water-soluble acrylic coating material that was used in the preceding application process, applying the mixed solution to Japanese paper with a roll coater, arranging a heating plate (220° C.) which is to be used in the hot pressing process in position at a distance of 50 mm from the application surface, and injecting hot steam (145° C.) into the gap thus formed.

With this process, the Japanese paper was modified into an acrylic resin sheet and both the lining function for the cherry veneer and the function of shielding moisture supplied from the base material side were provided. Moreover, because the pigment (titanium oxide white) of the water-soluble acrylic coating material could provide paper with a certain color base tone, it became possible to avoid the effect produced by the color tone and grade of the hardwood of the base material on the color tone and grade of the veneer. Thus, functions identical to those of a transfer sheet made from a resin could be easily provided with a Japanese paper.

In application to the Japanese paper in the steam impregnation process C, Japanese paper setting process, and application process of the water-soluble acrylic material with the rotor coater, the process can be simplified by applying the same water-soluble acrylic coating material on both sides of the Japanese paper and then setting on the lauan plywood.

### Working Example 4

In Working Examples 1 through 3, the steam impregnation process in accordance with the present invention can be implemented in a prime coating process after setting the cherry veneer and hot pressing. Thus, the coating process is composed of:
workpiece preheating at 40° C.;
aqueous coloration with a sponge roll;
jet heater drying (sheet temperature is maintained at 50° C.),
steam impregnation process D, and
coating material curing and drying process.

Thus, the steam impregnation process D was implemented by a method comprising the steps of using a mixed solution prepared by mixing colloidal silica with a water-soluble acrylic coating material of an EB-curable type, applying the mixed solution to a cherry veneer surface with a roll coater (equipped with a heater), then arranging a heating plate (220° C.) which is to be used in hot pressing at a distance of 50 mm from the application surface and injecting hot steam (145° C.) into the gap. Then, the water-soluble coating material having colloidal silica mixed therewith was EB cured in an electron beam irradiation drying furnace.

As a result, the coloration process and impregnation solidification of the EB-curable acrylic resin and silica could be completed by a series of processes and the strength and toughness of the cherry veneer provided on the surface of the plywood could be increased.

### Working Example 5

An example of implementing the steam impregnation in accordance with the present invention on a veneer after molding will be explained with reference to a novel molding process in which a veneer is insert molded in a resin material. First, as for the veneer configuration pasting, veneers of two types with a thickness of 0.5 mm are laminated by taking the wood grain orientation into account, then a high-grade wood veneer with a thickness of 2 mm is laminated, and bonding is conducted with a thermoplastic adhesive applied between all the veneers, or by placing thermoplastic films between all the veneers and press bonding.

Further, during the above-described veneer configuration pasting, biodegradability of the veneer can be maintained by using a biodegradable film such as a polylactic acid film or a cellulose acetate film. Moreover, the veneer reinforcement can be also conducted by blending a finely powdered inorganic substance with a particle size of 5 μm or less with the film resin and molding into a sheet.

The above-described laminated veneer is then deformed with a metal mold press to obtain a desired shape such that can be inserted and disposed in an injection molding mold. In this case, the moisture content ratio is maintained 10% or less by steam heating and compression molding is conducted so as to obtain a total thickness of, for example, from 1.2 mm to about 0.3 mm.

The molded veneer is inserted and disposed in the prescribed mold for injection molding. Then, injection molding of a resin is conducted and the resin is integrated with the veneer. Here, using a blend of a lignin extracted resin powder of a single pure type that was extracted, for example, from cedar of the same type and a vegetable fibrous powder such as commercial natural cellulose (mixing ratio 3:7) as the resin for injection molding instead of the conventional ABS resin or acrylic resin makes it possible to almost match the thermal expansion coefficients of all the materials and to resolve the problems of veneer peeling. The aforesaid blended resin is a thermosetting resin for this time only.

Implementing the steam impregnation process in accordance with the present invention prior to conducting application to the surface of the above-described laminated veneer or during the application process results in solidification such that prevents the occurrence of springback in the veneer after molding. Thus, any of the coloration process and impregnation and solidification of silica and an EB-curable acrylic resin identical to those of the steam impregnation processes A, B, C of Working Example 1 and steam impregnation process D of Working Example 4 can be implemented.

Further, when a multilayer high-grade coating is carried out or grade labeling is further conducted with a transfer sheet, those coating or transfer process can be implemented after impregnation with silica by the process identical to the steam impregnation process A of Working Example 1 or after conversion into a resin by impregnation with liquid paraffin of the steam impregnation process B.

### Working Example 6

In Working Example 2, a veneer plywood was used that was obtained by steam impregnating colloidal silica by the steam impregnation process A into a Japanese paper laminated in the plywood 2 and the surface cherry veneer 3, and the so-called R grooves were obtained by conducting press R groove processing under a pressure of 80 to 130 kg/cm² with a metal mold 1 having a cross-sectional shape shown in FIG. 1. Various groove molds with a central projection height of 2 mm and a projection width of 0.3 to 1.0 mm were tested. In all the cases, the groove depth on the veneer side was 1.5 to 1.7 mm.

Furthermore, veneer plywood of two types prepared by steam impregnating colloidal silica and a water-soluble acrylic coating material were used and multiple parallel R grooves were provided by conducting a press R groove processing under a pressure of 80 to 130 kg/cm² with a press mold with a cross-sectional shape shown in FIG. 1. The mold protrusion had the following dimensions: protrusion height h=1.7 mm, total protrusion width W=8 mm, radius, R₂₌₅ mm, and radius R_{1=0.3} mm.

In the case of the cherry veneer that was processed by the conventional method using absolutely no impregnation, even when the press V groove processing was conducted under a pressure of 40 to 50 kg/cm², the veneer was immediately cracked, and when a moistening test was conducted, the grooves returned to a state in which they almost looked flat due to the springback effect. Further, when the press R groove processing was conducted under a pressure of 40-50 kg/cm² by using the mold in accordance with the present invention, the immediate cracking of the surface was small but cracks appeared in the veneer, or even when the groove forming could be conducted without cracking, the grooves returned to a state in which they looked as stripes due to the springback effect in all the moistening tests.

Further, when a cherry veneer treated by the conventional process was subjected to a press V groove processing and then subjected to the usual coating process used for floors or wall materials, for example, when coatings of various well-known types were applied, e.g., with a roll coater, a sprayer, or a brush, and thoroughly dried and then water was applied to the V grooves and a hot kettle filled with warm water was placed thereon, with all the coatings, the springback effect occurred in the V grooves and decorative grooves became invisible.

In the case of cherry veneers in accordance with the present invention, coating was conducted after the press R groove processing, with a roll coater that is typical for applications to floor materials and similar tests were conducted after drying. No springback was observed.

In the above-described mold, the rising portion from the central protrusion had a required R shape with a single radius or complex radii, as shown in the figure. Therefore, even with the non-treated cherry veneer obtained by the conventional process, the aforesaid immediate surface cracking was small. However, the conventional springback effect was similarly visible.

With both the colloidal silica and the liquid paraffin as the steam impregnation objects in accordance with the present invention, no fracturing or hair cracking appeared in the veneer in the R groove portion formed by any of the metal molds and no springback effect was observed in the moistening test.

### Working Example 7

A commercial MDF sheet was used, the surface thereof was steam impregnated with liquid paraffin, a decorative paper (23 g/m²) for timber industry and a cherry veneer with a thickness of 0.2 mm were pasted thereon, then a water-soluble acrylic coating material was steam impregnated and roll R groove processing was conducted with the roll mold shown in FIG. 1 under the same conditions as those of Working Example 6.

The steam impregnation process will be described below in greater detail. Thus, the surface of the MDF sheet was steam impregnated with liquid paraffin by the steam impregnation process B. Then, the decorative paper or cherry veneer was pasted by gluing (urea resin+vinyl acetate) with a glue spreader, and the surface of the pasted decorative paper or cherry veneer was steam impregnated with the water-soluble acrylic coating material by the steam impregnation process A of Working Example 1.

As a result of pasting the decorative paper and cherry veneer onto the surface of the MDF sheet and conducting press R groove processing of Working Example 6, no rupture of the decorative paper or cracking of the cherry veneer in the R groove portions was observed and no springback effect was produced in the moistening test.

### Working Example 8

The roll R groove processing with the roll mold with a protrusion height of 2.1 mm was conducted on a substrate material in which a decorative paper or cherry veneer was pasted on a MDF sheet by the process identical to that of Working Example 7. In the mold protrusion, the zones close to the protrusion tip having a radius R₁ shown in FIG. 1 were extended to provide a U-like shape. Other portions were in the form of circular arc similarly to FIG. 1. The aforesaid extending portions had an R protrusion shape composed of a combination of multiple circular arcs.

After the roll R groove processing, the surface of the decorative paper or cherry veneer was steam impregnated with a water-soluble acrylic coating material by the steam impregnation process A identical to that of Working Example 1. No rupture of the decorative paper or cracking of the cherry veneer in the R groove portion was observed in the preceding processes and no springback effect was produced in the moistening test.

### Working Example 9

In the case of Working Example 6, the Japanese paper layer prevented the migration of moisture from the plywood. Therefore, all the portions of the surface layer that were subjected to plastic deformation were modified. As a result, not only the springback effect in the R groove portions, but also warping of the plywood itself was prevented. However, in the case of the MDF sheet of Working Example 7, all the surface portions were modified, but the migration of moisture from the rear surface side of the MDF sheet was not prevented. As a result, warping sometimes occurred in the MDF sheet itself.

Here, as shown in FIG. 2, pinholes or longitudinal grooves 6 of a very small width and a depth of 0.5 to 3 mm were provided in the MDF sheet material 5 of Working Example 7, over the entire surface of the material, or in the prescribed locations, or according to the prescribed pattern, and then liquid paraffin was steam impregnated by the steam impregnation process B and hot pressing was conducted. In this process, the amount of applied liquid paraffin was varied within a range of 150 to 300 g/m², but weight measurements confirmed that the entire liquid paraffin was impregnated in all the cases.

After the liquid paraffin was steam impregnated, the decorative paper and cherry veneer were pasted by the process of Working Example 7, and colloidal silica, water-soluble acrylic coating material, and liquid paraffin were steam impregnated into the surface of the pasted decorative paper and cherry veneer by the steam impregnation processes A, B, and C, respectively. Then, press R groove processing of Working Example 6 was conducted.

In the laminated MDF sheets in which, as described hereinabove, liquid paraffin was steam impregnated into the entire MDF sheet material and then various solutions were steam impregnated into the surface of the decorative paper of cherry veneer, no rupture of the decorative paper or cracking of the cherry veneer was observed in the R groove portion of the surface layer and no springback effect was observed in the moistening test, regardless of the type of treatment.

Then, a test was conducted by immersing the laminated MDF sheet into a warm water bath at a temperature of 40° C. and allowing it to stay therein for 5 h. Absolutely no problems such as peeling, partial collapse, warping, or bending were observed.

### Working Example 10

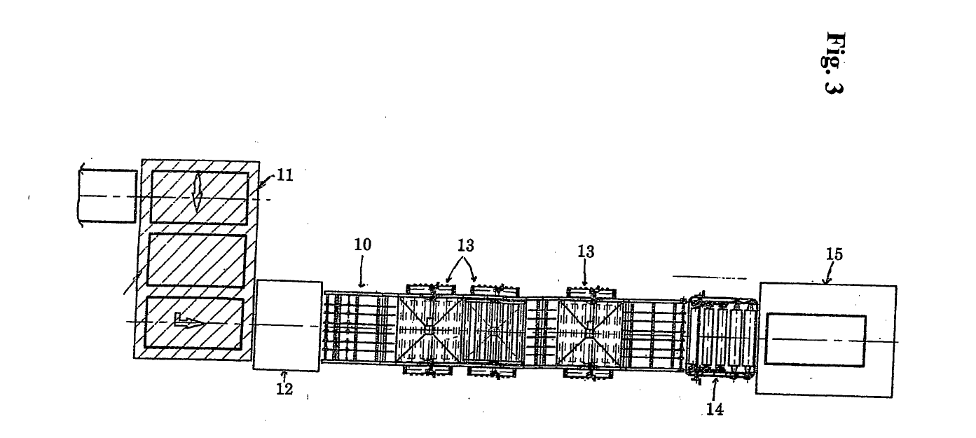

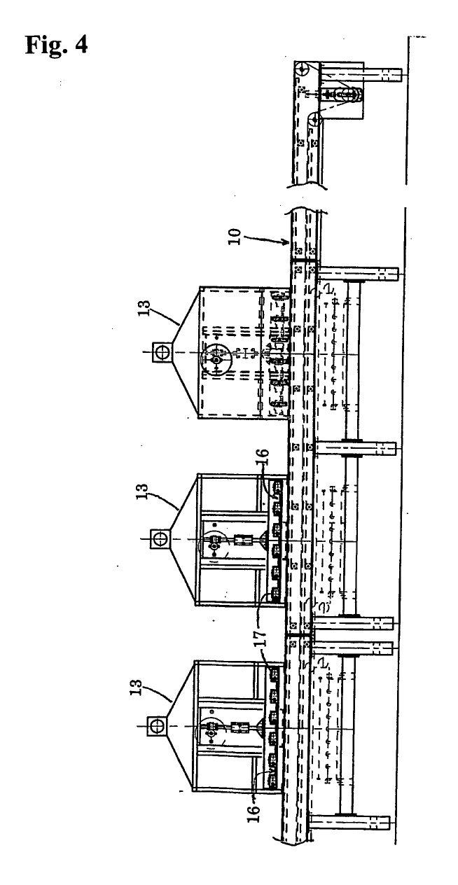

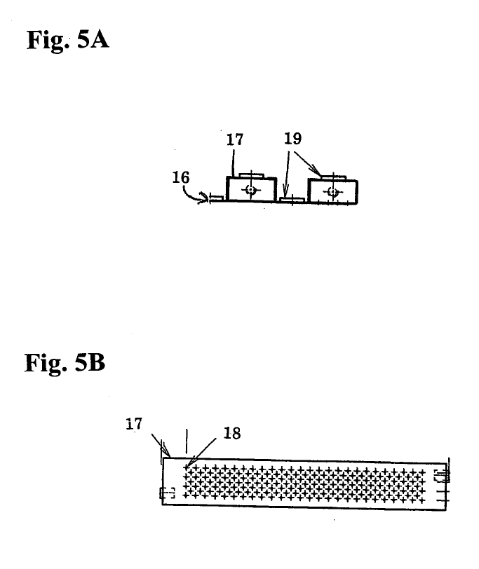

A variety of tests concerning resin impregnation, resin impregnation and coating, and coating in accordance with the present invention were conducted by using a floor sheet processing and production line in accordance with the present invention. More specifically, the production line, as shown in FIG. 3 and FIG. 4, comprises a conveyor line 10 for transporting a base material. A base material heating unit 11 is disposed at the initial stage, a roll coater 12 for application of a water-soluble coating material or adhesive, a steam impregnation unit 13 for steam impregnation and coating, and a hot roll 14 (iron press) for applying hot pressure to the base material are disposed at the next stage, and a high-frequency drying unit 15 for conducting moisture adjustment in the base material is disposed at the final stage.

Three steam impregnation units 13 shown in the figure comprise one heating plate 16 disposed via the prescribed distance opposite the base material present on the conveyor 10. Each heating plate 16 has a configuration provided with six steam introducing portions 17, and a plurality of heaters are carried on each heating plate 16, including the top surface of the steam introducing portion 17. A multiplicity of steam nozzle holes 18 are disposed with the prescribed spacing, as shown in the figure, on the surface (lower surface) of the steam introducing portions 17 that faces the base material. High-temperature and high-pressure steam introduced form the steam generating unit (not shown in the figure) into the steam introducing portions 17 is released from the steam nozzle holes 18 into the gap space formed with the top surface of the base material.

In order to conduct resin impregnation of the water-soluble coating material with the object of modifying the base material surface, for example, the base material is heated to a temperature of 50° C. or higher with the base material heating unit 11, the water-soluble coating material is applied in an amount which is not higher than the impregnable amount with a roll coater 12 by taking into account the porosity of the required surface layer portion of the base material, steam impregnation is carried out in the steam impregnation unit 13, a hot pressure is applied to the base material with a hot roll 14, and drying is conducted with a high-frequency drying unit 15 for conducting moisture adjustment in the base material.

In order to conduct resin impregnation of the water-soluble coating material and also to form a coating film with the object of modifying the base material surface, for example, the base material is heated to a temperature of 50° C. or higher with the base material heating unit 11, the water-soluble coating material is applied in an amount which is not higher than the impregnable amount with a roll coater 12 by taking into account the porosity of the required surface layer portion of the base material, steam impregnation is carried out in the steam impregnation unit 13, and drying is conducted with a high-frequency drying unit 15 for conducting moisture adjustment in the base material, without using the hot roll 14.

In order to form a coating film on the base material surface, the base material is maintained at a temperature of 40° C. or higher without using the base material heating unit, the prescribed amount of the water-soluble coating material is coated with the roll coater 12, steam impregnation is conducted with the steam impregnation unit 13, and drying is conducted, if necessary, with a high-frequency drying unit 15 for conducting moisture adjustment in the base material, without using the hot roll 14.

When the above-described three methods were implemented, if the temperature of the base material were constant, the degree of resin impregnation into the base material surface was different and could be controlled by appropriately selecting the heater temperature and steam temperature in the steam impregnation unit 13.

On the other hand, it was confirmed that if the temperature of the heating plate 16 in the steam impregnation unit 13, the gap size, and steam temperature were within the prescribed ranges, the impregnated amount basically could be controlled by selecting the appropriate base material temperature from a range of 0° C. to 60° C. Thus, the higher was the temperature, the greater became the impregnated amount, and when the base material temperature was 40° C. or less, the impregnated amount started to decrease significantly, at a temperature of 25° C. or less, practically only application was possible, and in a range of 20° C. to 0° C. no impregnation could be conducted.

In the floor sheet processing and manufacturing line of the above-described configuration, a transfer roll was disposed between the steam impregnation unit 13 and hot roll 14 to convert the line into a manufacturing line with a transfer processing configuration. The object of impregnation in this line was selected so that an adhesive remained on the base material surface as a water-soluble adhesive, for example, of a melamine resin system, which is the same component as the coating material. As a result, in addition to the modification of the surface layer by impregnation, it was possible to fix uniformly the adhesive that was used for the modification and demonstrated an anchor effect. Therefore, transfer films provided with resin layers or vapor deposited layers of a metals or ceramics of a variety of patterns could be easily pasted, and then the transfer films could be removed and the transfer layer could be strongly bonded to the base material surface.

### INDUSTRIAL APPLICABILITY

The present invention made it possible to increase the hardness and strength of the surface layer portions, for example, of cedar sheets or cedar plywood, which are the soft materials, in a simple manner, without providing a coating film or a resin component layer such as a resin film by the conventional typical coating process. The modified single sheets or plywood had high weather and water resistance despite the absence of coating films, were not affected by UV radiation or moisture and were suitable for a variety of applications. Moreover, various well-known coating processes and transfer films can be employed as necessary according to the requirements placed on the application or design, and the application and utilization range of cedar sheets or cedar plywood, which have been strictly limited because the surface of such materials is soft and can be scratched easily, can be greatly expanded.

In accordance with the present invention, as was clearly shown in the working examples thereof, impregnating silica and resins into plywood of various types allows for the fabrication of strengthened plywood suitable for a variety of applications. Another effect obtained with the steam impregnation method in accordance with the present invention is that block-type water-soluble acrylic resins can be impregnated into a plywood surface, hardness, water resistance, and heat resistance of the surface can be improved, the anchor effect induced by the impregnation of the resin into woody fibers can be activated, and the adhesion strength of coatings or adhesives in subsequent processing can be greatly improved.

With the conventional technology, aqueous coating materials could be applied to the surface of inorganic materials, but were very difficult to impregnate. Accordingly, only coating materials using organic solvents were used to ensure quality and improvement of properties such as hardness, corrosion resistance, and water resistance which are required according to application of inorganic materials. By contrast, the present invention made it possible to impregnate aqueous coating materials into inorganic material sheets.

In accordance with the present invention, surface treatment of a porous materials of a variety of types is made possible by employing a combination with the E.B. technology using coating materials polymerizable with electron beams. Thus, the improvement of hardness, water resistance and heat resistance of various material surfaces can be attained by using a radical polymerizable water-soluble coating material, mixing colloidal silica therewith, adjusting the viscosity, and impregnating by the steam impregnation method in accordance with the present invention.

Further, the steam impregnation in accordance with the present invention also makes it possible to impregnate a liquid paraffin into wooden materials, paper, and the like, and such an impregnation can be conducted in any regions and with a very high uniformity on the entire surface of the material or locally. The strength, hardness, water resistance, and scratch resistance of the wooden materials and paper impregnated with liquid paraffin are greatly improved. In particular, thin veneer or paper can be modified to a level of resinifying, without changing the external appearance or decorative properties thereof.

With the method for the manufacture of a substrate material in accordance with the present invention, the design peak-valley shape in the form of grooves and the like can be reliably provided on decorative materials such as paper or films, without rupturing the materials. The design peak-valley shape in the form of grooves and the like is not restored to the original shape due to springback even when the material is humidified or moisture is applied thereto after molding. Thus, wooden parts can be provided with stable plastic deformation which does not change with time after molding.

Further, if a block-type water-soluble acrylic resin is impregnated into a plywood surface by the steam impregnation method in accordance with the present invention, hardness, water resistance, and heat resistance of the surface can be improved, the anchor effect induced by the impregnation of the resin into woody fibers can be activated, and the adhesion strength of coatings or adhesives in subsequent processing can be greatly improved.

Moreover, the working examples clearly demonstrated that in actual floor sheet processing and transfer manufacturing lines, it is possible to use a water-soluble adhesive and modify the surface layer by impregnation and also to provide the adhesive used for the modification with an anchor effect, thereby fixing it uniformly to the surface and making it possible to paste a transfer film provided, for example, with a deposited layer of a metal or ceramic, to the base material and bond the adhesive layer strongly to the base material surface. Therefore, in addition to increasing the strength of the surface layer of wooden materials or inorganic sheet materials, it is also possible to provide for strong and intimate bonding of the deposited layer of metal or ceramic materials, such as if they were directly sputtered. Therefore, materials can be provided which are suitable for novel applications providing novel functions to wooden materials or inorganic sheet materials.

1. A method for surface layer modification, comprising the steps of:
applying a solution of organic or inorganic matter to the surface of an object to be treated; and
bringing steam into contact with the application surface and causing at least the organic or inorganic matter present in the solution to be impregnated at least into the surface layer of the object to be treated.

2. A method for surface layer modification, comprising the steps of applying a solution of organic or inorganic matter to the surface of an object to be treated;
bringing steam into contact with the application surface and causing at least the organic or inorganic matter present in the solution to be impregnated at least into the surface layer of the object to be treated; and
heating the treatment surface or the entire object to be treated.

3. A method for surface layer modification, comprising the steps of applying a solution of organic or inorganic matter polymerizable by UV radiation or electron beam to the surface of an object to be treated;
bringing steam into contact with the application surface and causing the organic or inorganic matter present in the solution to be impregnated at least into the surface layer of the object to be treated; and
polymerizing and solidifying the surface layer portion and the impregnated organic or inorganic matter by irradiating the treatment surface with UV radiation or electron beam.

4. The method for surface layer modification according to any one of claims 1 through 3, wherein a recess is provided in the surface of the object to be treated so that the location and depth of impregnation of the solution of organic or inorganic matter into the surface layer can be adjusted.

5. The method for surface layer modification according to any one of claims 1 through 3, wherein, in the impregnation step, the application surface is brought into contact with steam so as not to be wetted with the steam.

6. The method for surface layer modification according to any one of claims 1 through 3, wherein dry steam is used as the steam.

7. The method for surface layer modification according to claim 6, wherein the dry steam temperature is not lower than 120° C. and not higher than 250° C.

8. The method for surface layer modification according to claim 2, wherein, in the heating step, the contact of said steam with the application surface is conducted repeatedly in the same manner as in said impregnation step.

9. The method for surface layer modification according to any one of claims 1 through 3, wherein the steam which is in contact with the application surface is heated and thermally convected by heating means disposed in the vicinity of the application surface.

10. The method for surface layer modification according to any one of claims 1 through 3, wherein the steam is heated and convected by disposing a heating plate opposite the application surface and continuously or intermittently introducing the steam into the gap between the opposing surfaces, while heating the heating plate.

11. The method for surface layer modification according to any one of claims 1 through 3, wherein the steam is heated and convected by disposing a heating plate opposite the application surface and continuously or intermittently introducing the steam from the heating plate itself or from the clearance between a plurality of heating plates into the gap between the application surface and the opposing surface, while heating the heating plate(s).

12. The method for surface layer modification according to any one of claims 1 through 3, wherein in the impregnation step or heating step, the steam and the organic or inorganic matter are activated by using ultrasound oscillation means.

13. The method for surface layer modification according to any one of claims 1 through 3, comprising a step of heating the object to be treated before the application step, after said step, or before and after said process.

14. The method for surface layer modification according to any one of claims 1 through 3, wherein the solution of organic or inorganic matter comprises either a water-soluble coating material or a water-soluble adhesive as the main component.

15. The method for surface layer modification according to any one of claims 1 through 3, wherein the solution of organic or inorganic matter is either a water-soluble coating material or a water-soluble adhesive comprising fine inorganic particles.

16. The method for surface layer modification according to any one of claims 1 through 3, wherein the solution of organic or inorganic matter is either a water-soluble coating material or a water-soluble adhesive mixed with colloidal silica.

17. The method for surface layer modification according to any one of claims 1 through 2, wherein the solution of organic or inorganic matter comprises either colloidal silica liquid or liquid paraffin as the main component.

18. A modification apparatus used in the surface layer modification method according to claim 2, comprising:
heating means disposed opposite an application surface; and
steam generation means for heating and convecting steam by continuously or intermittently introducing the steam into the gap between the heating means and the application surface.

19. A modification apparatus used in the surface layer modification method according to claim3, comprising:
heating means disposed opposite the application surface;
steam generation means for heating and convecting steam by continuously or intermittently introducing the steam into the gap between the heating means and the application surface; and
irradiation means for irradiating the treatment surface with UV radiation or electron bear.

20. A modified product comprising a modified surface layer, which is obtained by applying a solution of organic or inorganic matter that comprises at least one of colloidal silica liquid, liquid paraffin, a water-soluble coating material or a water-soluble adhesive as the main component to the surface of a object to be treated having a surface layer of a wooden material, an inorganic material, or a ceramic material, impregnating the solution into said surface layer of the object to be treated and drying and solidifying the solution by steam which is brought into contact with the application surface, thereby eliminating the film of said solution on the surface of said object to be treated and increasing the hardness of the surface layer.

21. The modified product according to claim 19, wherein the solution of organic or inorganic matter contains fine inorganic particles.

22. The modified product according to claim 19, wherein the solution of organic or inorganic matter comprises at least one of water-soluble coating materials or water-soluble adhesives polymerizable by UV radiation or electron beam.

23. A modified product that is converted into resin by containing liquid paraffin steam-impregnated into a thin sheet material or paper.

24. A coating method for a coating material, comprising the steps of:
applying a coating material to a coating object; and
forming steam atmosphere between a surface to be coated and a heating plate disposed in the vicinity of said surface and solidifying the applied coating material.

25. A coating method for a coating material, comprising the steps of:
applying a coating material to a coating object;
controlling the coating object to a prescribed temperature; and
forming steam atmosphere between a surface to be coated and a heating plate disposed in the vicinity of said surface and solidifying the applied coating material.

26. A coating method comprising the steps of:
applying an adhesive to a coating object;
controlling the coating object to a prescribed temperature; and
forming steam atmosphere between a surface to be coated and a heating plate disposed in the vicinity of said surface and fixing the applied adhesive.

27. An impregnation and coating method for a coating material, comprising the steps of:
applying a coating material to a coating object;
controlling the coating object to a prescribed temperature;
forming steam atmosphere between a surface to be coated and a heating plate disposed in the vicinity of said surface and impregnating the applied coating material into the surface layer of the surface to be coated of the coating object that is being heated; and
forming steam atmosphere between said heating plate and the surface to be coated and solidifying said coating material that remained on or was applied to the surface to be coated of the coating object that is being neither cooled nor heated, after said impregnation process.

28. An impregnation and coating method, comprising the steps of:
applying an adhesive to a coating object;
controlling the coating object to a prescribed temperature;
forming steam atmosphere between a surface to be coated a heating plate disposed in the vicinity of said surface and impregnating the applied adhesive into the surface layer of the surface to be coated of the coating object that is being heated; and
forming steam atmosphere between said heating plate and said surface to be coated and fixing said adhesive that remained on or was applied to the surface to be coated of the coating object that is being neither cooled nor heated, after said impregnation process.

29. The impregnation and coating method according to claim 27 or claim 28, wherein in the impregnation step, the quantity of the coating material or adhesive impregnated into the surface layer of the application surface is controlled by controlling at least one of the coating object temperature, coating material temperature, and steam temperature.

30. The impregnation and coating method according to claim 27 or claim 28, wherein in the temperature control of the coating object, the heating temperature of the coating object during impregnation is 50° C. or higher, and the temperature of the coating object during solidification or fixing of the coating material is 40° C. or less.

31. The coating method according to any one of claims 24 through 28, wherein the steam temperature is 120° C. or higher.

32. The coating method according to any one of claims 24 through 28, wherein the steam temperature is 140° C. or higher.

33. The coating method according to any one of claims 24 through 28, wherein the steam pressure prior to releasing between the heating plate and the surface to be coated is 2 MPa or higher.

34. The coating method according to any one of claims 24 through 28, wherein the steam pressure prior to releasing between the heating plate and the surface to be coated is 4 MPa or higher.

35. The coating method according to any one of claims 24 through 28, wherein the temperature of the heating plate is 200° C. or higher.

36. The coating method according to any one of claims 24 through 28, wherein the temperature of the heating plate is 300° C. or higher.

37. The coating method according to any one of claims 24 through 28, wherein the distance between the heating plate and the surface to be coated is 5 to 20 mm.

38. The coating method according to any one of claims 24 through 28, wherein the coating material or adhesive is a water-soluble coating material or a water-dispersible coating material component comprising any one from alkyd resins, melamine resins, urea resins, phenolic resins, acrylic resins, and epoxy resins as the main component.

39. The coating method according to claim 38, wherein the coating material or adhesive is a dispersion of a resin component and fine inorganic particles in an aqueous medium.

40. The method for coating a water-soluble coating material, according to claim 39, wherein the water-soluble coating material comprises 20 wt. % or less of the resin component and 5% or less of the fine inorganic particle component.

41. The coating method for a water-soluble coating material, according to claim 39, wherein the water-soluble coating material comprises 15 to 18% resin component and 2 to 5% fine inorganic particle component.

42. The coating method according to claim 39, wherein the fine inorganic particles are SiO₂ with a mean particle size of 50 nm or less.

43. The coating method according to claim 27 or claim 28, wherein the fine inorganic particles contained in the coating material or adhesive applied during the impregnation step are SiO₂ with a mean particle size of 20 nm or less, and the fine inorganic particles contained in the coating material or adhesive applied during the coating step are SiO₂ with a mean particle size of more than 20 nm and not more than 50 nm.

44. A coating apparatus comprising:
a carrying or holding unit for a coating object, comprising heating or cooling means for adjusting the temperature of the coating object to a prescribed temperature;
a coating unit for coating the coating material or adhesive on a prescribed surface of the coating object;
a heating plate unit in which a heating plate is arranged in the vicinity of the surface to be coated and which maintains the heating plate at a prescribed temperature; and
a steam generating unit for forming steam atmosphere in the gap between the surface to be coated and the heating plate by releasing steam maintained at a high temperature and a high pressure into said gap.

45. A method for the manufacture of a substrate material, comprising the steps of:
impregnating a solution of organic or inorganic matter into a surface layer of a substrate material; and
forming a convex or concave shape in the surface layer of the substrate material by roll molding or press molding before and after the impregnation step.

46. A method for the manufacture of a substrate material, comprising the steps of:
impregnating a solution of organic or inorganic matter polymerizable by UV radiation or electron beam into a surface layer of a substrate material;
forming a convex or concave shape in the surface layer of the substrate material by roll molding or press molding before and after the impregnation step; and
polymerizing and solidifying the surface layer portion and the impregnated organic or inorganic matter by irradiating the treatment surface with UV radiation or electron beam.

47. The method for the manufacture of a substrate material, according to claim 45 or claim 46, wherein the convex or concave shape has a rounded groove shape.

48. The method for the manufacture of a substrate material, according to claim 45 or claim 46, wherein the substrate material is a single sheet of a wooden material or an inorganic material, a laminated sheet comprising a wooden material or an inorganic material, or said single sheet or laminated sheet having a decorative material on the surface.

49. The method for the manufacture of a substrate material, according to claim 45 or claim 46, wherein the step of impregnating the solution of organic or inorganic matter is conducted by a steam impregnation process comprising the steps of bringing steam into contact with the substrate material after applying the solution of organic or inorganic matter, impregnating the solution of organic or inorganic matter at least into the surface layer of said material, and heating the treatment surface or the entire material.

50. The method for the manufacture of a substrate material, according to claim 45 or claim 46, wherein the solution of organic or inorganic matter is any of water-soluble coating materials or adhesives, or water-soluble coating materials or adhesives containing fine inorganic particles (including colloidal silica).

51. The method for the manufacture of a substrate material, according to claim 45 or claim 46, wherein a metal mold used in roll molding or press molding comprises a rounded protrusion of a circular arc form including no straight lines and the cross-sectional shape thereof in the vertical plane orthogonal to the longitudinal direction of the protrusion is composed of a plurality of circular arcs.

52. A mold for molding a substrate material, which is provided with a protruding portion in the mold surface and used for roll molding or press molding, the mold comprising a rounded protrusion of a circular arc form including no straight lines and the cross-sectional shape thereof in the vertical plane orthogonal to the longitudinal direction of the protrusion is composed of a plurality of circular arcs.

53. The mold for molding a substrate material according to claim 52, wherein the rounded protrusions of the mold are arranged parallel to each other.
